(19) United States
(12) Patent Application Publication
(10) Pub. No.: US 2007/0246573 A1
(43) Pub. Date: Oct. 25, 2007

(54) Securing Method, Manufacturing Method, and Secure Spraying Endpiece

(76) Inventor: Claude Jaunay, Le Mans (FR)

Correspondence Address: YOUNG & THOMPSON, 745 SOUTH 23RD STREET, 2ND FLOOR, ARLINGTON, VA, 22202, US

(21) Appl. No.: 11/664,599

(22) PCT Filed: Oct. 18, 2005
(86) PCT No.: PCT/FR05/02576

§ 371 Date: Apr. 4, 2007

(30) Foreign Application Priority Data
Oct. 19, 2004 (FR) 0411095

(51) Int. Cl. B05B 1/14

(52) U.S. Cl. 239/548; 29/428

(57) ABSTRACT

The invention concerns a method for making secure an endpiece comprising the production of an endpiece with nozzle fitted on a fluid-guiding body. During the manufacture of the endpiece, surface irregularities (26, 28) are formed on the nozzle (16) and a guide body (10), and after the endpiece has been produced, an enveloping layer of plastic material (30) is formed by overmoulding, on at least a major part of the endpiece, in particular on the irregularities (26, 28), except on an opening (32) surrounding the spraying orifice (18) of the nozzle (16), the opening being sufficiently small for preventing the nozzle (16) from passing therethrough. The invention is applicable to spray endpieces for therapeutic applications.

This invention covers a process for enhancing the safety of atomizer nozzles, particularly those used in medical treatments, a production process for said nozzles and enhanced nozzles.

The invention is intended for nozzles to be used in medical treatments, meaning oral, nasal, ocular or aural applications. Nevertheless, the invention applies to all atomizer devices for liquid products of the so-called “external spray jet” type.

In general, there are two types of nozzles, depending on whether the spray jet is “internal” or “external”.

French patent No. 2 547 737 covers an internal spray jet type nozzle that has a casing that forms a propulsion tube from a spray nozzle in which a rod is mounted. The rod is thicker than the atomizer aperture and thus cannot be projected outside the nozzle. This type of nozzle offers a decent level of safety but is not very reliable or accurate. In fact, usually caused by bad assembly, by the nozzle assembly being dropped, or by a serious mishandling of the assembly containing the nozzle, the rod may be moved out of position so that the spray angle, speed of propulsion and size of the particles emitted vary.

Nozzles with external jets have a spray jet part that is forced onto the body and enclose the spray aperture. In order for these parts of the spray jet to be firmly attached to the body, they are force-fitted over the body using an assembly machine that exerts high pressure and sometimes causes the spray jet part to break into components. Thus, the basic problem with these nozzles is that, if the aperture is clogged when high pressure is applied, part of the spray jet may be projected into either the mouth or the nose with the risk of being swallowed or inhaled, or into the eye or ear, potentially causing injury.

Although these nozzles with external spray jets provide good accuracy and good reproducibility, and although accidents caused by the ejection of components are quite rare, their use is nevertheless inappropriate in some applications due to the danger of components being ejected.

The purpose of this invention is to combine the safety of internal spray jet nozzles, which do not allow any part to be ejected, with those of the reliability and accuracy of external spray jet nozzles.

Thus, the purpose of the invention is to eliminate any danger of an external spray jet type nozzle ejecting any component whatsoever. According to the invention, enhanced safety is obtained using the over-molding of a casing that clears the aperture of the spray jet but also prevents the latter from being expelled.

More precisely, it relates to a nozzle safety process that includes the production of an external spray jet nozzle force-fitted onto a liquid feed tube. According to the invention, the process includes, while the nozzle is being produced, the creation of surface irregularities on at least one of the components selected among the spray jet and the feed tube and, after the nozzle is produced, the creation by over-molding of a plastic casing on at least a large part of the nozzle and especially on the irregularities—except over an opening enclosing at least the spray jet aperture, with the opening being small enough that the external spray jet cannot pass through it.

The invention also covers a manufacturing process for an external spray jet type nozzle, composed of a first manufacturing phase for a feed tube that encloses a liquid feed tube and for a spray jet, and a second phase where the spray jet is assembled onto the feed tube in order to form the nozzle. According to the invention, the process has a third phase, in which the nozzle is rendered safe using the process described in the preceding paragraph.

Ideally, the process will have an additional nozzle ejection phase and all phases of the process will be executed sequentially on a single automatic machine with several work stations. For example, the automatic machine with several work stations would have at least the following: a work station for attaching the spray jet to the feed tube and an over-molding station, and the process would also have a spray jet attaching handler associated with the assembly station of the automatic machine.

The invention also covers a spray nozzle that has a liquid feed tube with at least one surface outcropping, a spray jet with at least one surface outcropping and a casing that works closely with the outcroppings on the feed tube and the spray jet.

Ideally, the feed tube and the spray jet constitute a continuous channel for transmitting the liquid that is entirely separate from the casing.

In one method of production, the spray jet is rigid and the passageway formed by the feed tube and the spray jet is uninterrupted between interior of the feed tube and the aperture of the spray jet

In another method of production, the nozzle has a movable pointer designed to close the spray jet aperture, mounted on an elastic component that brings it back to its closed position. The elastic component may be cylindrical, forming a movable piston fitting into the body. Ideally, the cylindrical component should be produced by the simultaneous molding of two materials, one rigid and the other compressible.

In another production process, the spray jet is composed of elastomer and, when there is no pressure, it forms a spring valve resting against the feed tube or an adjoining part of it, whereas when the liquid is under pressure, part of the elastomer spray jet moves away from the feed tube and allows the creation of a direct pathway for the liquid to flow to the exterior.

In a medical treatment application, all of the materials in contact with the liquid sprayed are approved for medical usage.

Other features and advantages of the invention will become clear upon reading the following description of types of production, which refer to the attached drawings, in which:

FIG. 1 is a cross-section of the end of a nozzle following the first method of production;

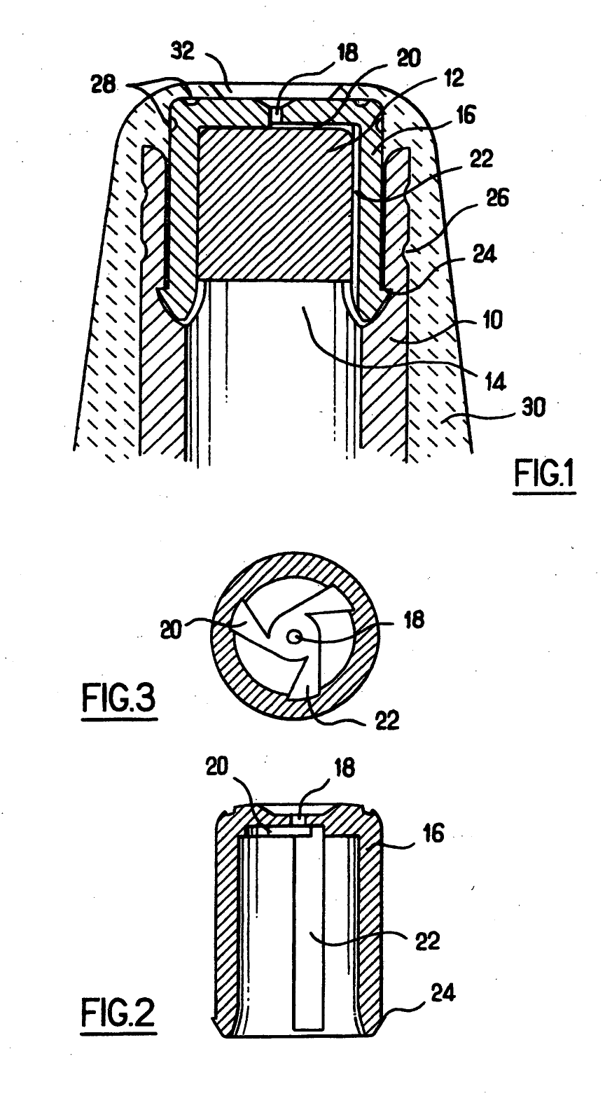

FIGS. 2 and 3 are longitudinal and horizontal cross-sections of a spray jet that is analogous to the one shown in FIG. 1;

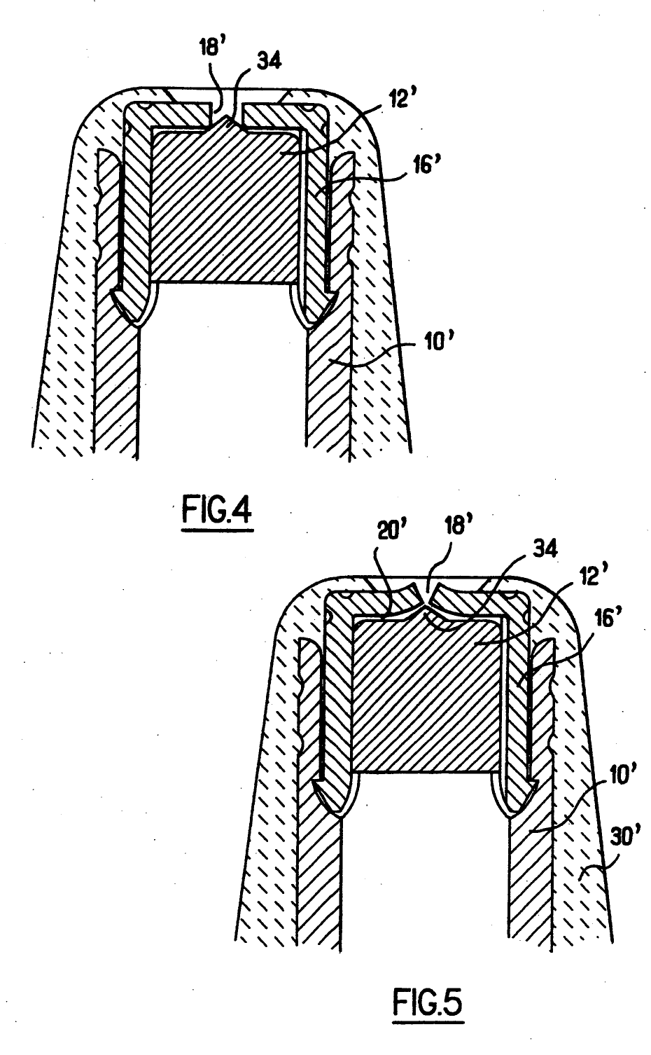

FIG. 4 is a cross-section of the end of a nozzle following the second method of production, in which the spray jet is made of elastomer and is in closed position;

FIG. 5 is analogous to FIG. 4 but shows the nozzle in open position during the expulsion of liquid; and

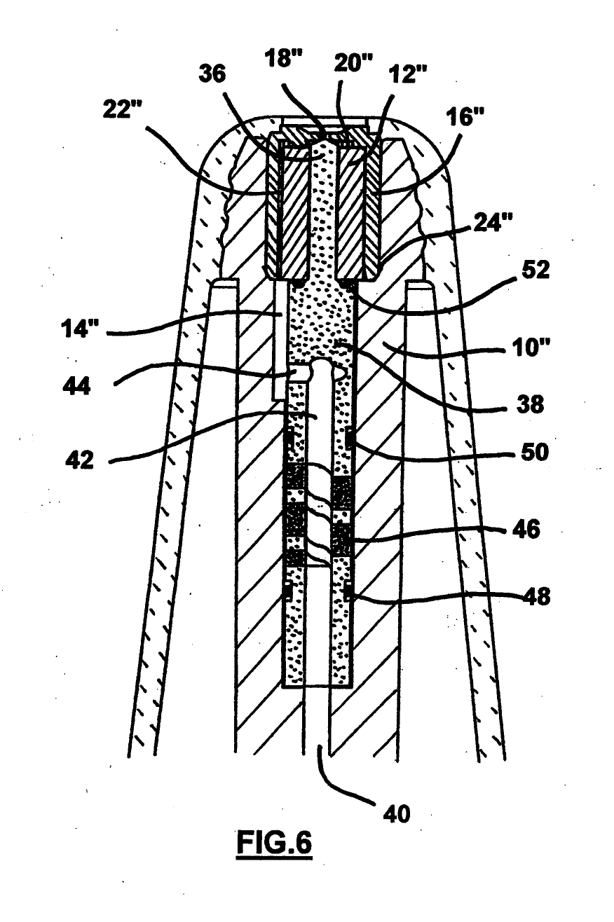

FIG. 6 is analogous to FIG. 1, but shows another method of producing the nozzle.

The nozzle shown in FIGS. 1 through 3 has a feed tube (10), the greater part of which is in the form of a round conduit which ends in a pin (12) that is joined to it. This pin (12) is connected to the conduit at two diametrically opposed points by components (14), and the whole body is made, ideally, in one piece by a molding process. This feed tube may be, for example, made of hard plastic designed for medical uses.

Between the pin (12) and a widened inner part of the feed tube (10), a round cylindrical cavity is formed into which the main part of a spray jet (16) fits. The latter, in addition to its cylindrical part, has a horizontal partition at the end which has a small spray aperture (18) at its centerpoint. On the inside of the spray jet, the end partition forms a so-called “swirl” atomizing chamber (20), shown in the shape of three non-radial arms, and a round central part, that serve to swirl the liquid, which then forms a fine spray.

The ends of the passageways open into grooves (22), of which there are three in the drawings, that, along with the chamber (20), make up a continuous passageway between the interior of the feed tube (10) and the aperture (18). The liquid, moving under pressure from a pump or other assembly linked to the nozzle, passes through the body (10) and then circulates in the grooves (22) to reach the atomization chamber (20) and be projected out through the aperture (18) in the form of a spray or atomization.

We have also depicted, at the end of the cylindrical part of the spray jet opposite the partition with the aperture (18), studs (24) allowing the spray jet to be hooked into the feed tube (10). Whether the spray jet is made of metal or plastic, especially elastomer, the connection between the stud (24) and the interior of the feed tube (10) is always made with a modicum of force. The role of this stud (24) is simply to hold the spray nozzle on the feed tube (10) temporarily during manufacturing. Thus, the feed tube and the spray jet together form a “nozzle”, but if it were to be used as is, the spray jet could easily be projected far from the body by even a low pressure of liquid.

We note that the feed tube (10) has, on the exterior, circular grooves (26) and that the spray jet itself also has, on the outside, grooves (28) that form outcroppings.

According to this invention, the assembly formed by the feed tube (10) and the spray jet (16) mounted on the pin (12) is subjected to an operation where a casing (30) is over-molded. This over-molding is done so that the casing covers a large part of the feed tube and the spray jet, especially by penetrating into the grooves (26) in the body (10) and into the grooves (28) of the spray jet (16), but leaves a large opening (32) around the spray aperture (18). Thus, the casing in no way disturbs the spray produced by the spray jet aperture. It should be noted that the opening (32) is clearly smaller than the spray jet.

The casing (30) is made of a plastic that has good properties of mechanical resistance. It may be made, for example, of a polyolefin such as polypropylene.

The nozzle shown in FIG. 1 forms a continuous passageway from the inside of a pump or canister up to the spray aperture (18). The nozzle thus has no way of keeping bacteria out.

FIGS. 4 and 5 show another method of producing the invention that prevents the entry of bacteria. In these figures, we have used the same reference keys as in FIG. 1, followed by an apostrophe (') to designate analogous components.

It is to be noted that the pin (12′) has a conical stud (34) that sticks out in the center, across from the aperture (18′) of the spray jet (16′). The spray jet (16′) is made of elastomer. The interior edges (15) of the aperture (18′) are in contact with the conical stud (34) when the interior of the feed tube (10′) is not under pressure. On the other hand, when pressure is applied inside the feed tube (10′), the pressurized liquid in the chamber (20′) spreads the lips of the casing (18′), which move away from the stud (34) and thus form a continuous passageway allowing atomization to occur. As soon as the internal pressure disappears, the elastomer on the spray jet (16′) brings the internal edges of the aperture (18′) into contact with the conical stud (34) of the pin (12′). The stud (34) and the lips of the aperture thus form a valve that prevents the entry of bacteria.

The method of production shown in FIG. 6 involves a body (10″) into which a pin (12″) is placed, onto which a spray jet (16″) is set. The spray jet has an aperture (18′). The inside of the spray jet encloses, as in the method of production described in referring to FIGS. 1-3, an atomization chamber (20″).

Compared with the method of production in FIGS. 1-3, the one in FIG. 6 differs in that the spray jet aperture (18″) may be closed off by a center punch (36), thus constituting a valve that prevents the entry of bacteria. The center punch (36) is mounted on a cylindrical elastic component (38) forming a piston. As shown in FIG. 6, the grooves (22″) are fed liquid by the exposed parts (14″), ideally by at least two that are diametrically opposed, receiving the liquid from a tube (40) linked to the associated container by a conduit (42, 44) formed inside the cylindrical component (38).

We note that the elastic component (38) on the side of the container is held solidly in place in the body (10″) by interposing a gasket (48) that may be joined to the middle component (46). The plastic component (38) that is between this fixed lower part and its upper center punch part (36) is mobile and has a middle section (46) made of a compressible material. An additional gasket (50) may be placed between the body (10″) and the cylindrical component (38) and may be joined to the middle section (46). Lastly, grooves (52) are formed in the elastic component (38) or in the pin (12″) so that the liquid can go between these two components.

In normal resting position, the compressible part (46) of the elastic component (38) pushes the center punch (36) against the spray jet aperture (18′) so that the interior of the nozzle is completely cut off from outside air: the device constitutes a valve that prevents the entry of bacteria. When liquid under pressure flows through the canal (40, 42, 44) and through the component (14″) and reaches the atomization chamber (20″) via the grooves (22″), it also reaches the grooves (52) and exerts pressure on the entire surface of the elastic body (38) minus the surface of the center punch. The resulting force from the pressure thus tends to move the center punch (36) away from the aperture (18″) of the spray jet, and since the body (38) has a compressible part (46) it moves the center punch (36) away from the spray jet. Atomization thus takes place immediately. As soon as the pressure dissipates, the compressible part (46) of the elastic component (38) springs back and brings the center punch (36) up against the aperture (18″) of the spray jet again.

The device providing the elastic component (38) with its compressibility may be of various types. Besides the plastic molded spring joined to the part (38) just described, we know of many elastic materials, such as closed-cell flexible foam rubber and even mechanical components such as springs.

The production method shown is of particular interest from the manufacturing point of view since, thanks to the spiral shape of the compressible material (46), the elastic component (38) may be produced in a single piece by the simultaneous molding of two materials: manufacturing and assembly are simplified and serve to reduce the cost of the nozzle thus obtained.

Although we have shown a feed tube and spray jet in which a flow of liquid is formed by a groove made on the inside wall of the spray jet, it is quite clear that this groove may be formed on the outside wall of the pin (12). Likewise, although the atomization chamber (20) (20″ formed on the inside wall of the spray jet) has been depicted, it can be formed on the end surface of the pin (12).

Likewise, although in FIGS. 4 and 5 we have depicted a spray jet composed of elastomer that moves away from a relatively rigid stud on the pins of the feed tube, one may use an inverse arrangement in which the guide pin stud has elastic properties and moves away from the spray jet aperture, which in this case may be rigid. One may also combine these features in a number of ways: for example, the pin (12) and the spray jet can both be composed of elastomer.

Let us now consider the manufacture of a nozzle as shown in FIGS. 1-3. Although the operations made be performed separately, on two different machines, it is particularly advantageous to use one machine with several stations.

For example, in the case of a machine with four stations, the first station is used for molding the feed tube (10).

At a second station, while this tube is cooling down, a handler places a spray jet (made separately) on the feed tube in an assembly operation.

At a third station, the feed tube and the spray jet are set in a mold for the over-molding that will make up the casing (30), composed of polypropylene, for example. This operation is ideally performed without deforming the feed tube or the spray jet, regardless of the materials they are made of.

Lastly, the fourth station is used to eject the nozzles produced.

Such a machine reduces production time since, on one hand, the feed tube may be equipped with the spray jet as soon as assembly is feasible and, on the other hand, the entire time elapsed during passage from the first to last stations serves to cool the feed tube. Thus, the entire manufacturing cycle for the nozzle described above may be on the order of 15 sec, meaning half the time required to manufacture a comparable nozzle in which the external spray jet is force-fitted. In addition, thanks to the over-molding, one can reduce the thickness of the feed tube and thus the length of the manufacturing cycle and the cost of the nozzles.

One can, however, use any other technology in the manufacturing that involves, for example, movement of mold sections, the use of handlers, etc.

One perceives that, given the low cost of the various components used (since they are tiny), the main production cost derives from the time the machine is in use. One thus comes to the realization that the cost of the nozzles with enhanced safety due to the invention may be much less than that of traditional nozzles that present a danger of a component being ejected during their use.

We have not described in detail the exact nature of the materials used or the specific characteristics of the manufacturing phases, on one hand because they are well known to experts in the field, and on the other because they will vary depending on which particular type of nozzle is produced.

Although we have described the invention in terms of a nozzle with an external spray jet, it also applies to nozzles with an internal spray jet. In the latter case, the first work station is used to mold the feed tube. At the second station, while the body is cooling down, a handler places a spray jet (made separately) on the feed tube in an assembly operation. At the third station, the tube-spray jet assembly is over-molded through the formation of the casing this is made, for example, of polypropylene. Since the tube-spray jet assembly is not subjected to any insertion force, there is no risk of it being deformed. The fourth station is used to eject the nozzles produced. A greater level of precision (15) for directing the spray is thus obtained.

The invention applies to all types of push-buttons currently used to produce spray from a nozzle.

The invention thus offers a process for enhancing the safety of nozzles of the known type, the manufacture of safer nozzles, and specially produced safer nozzles.

A specialist in the field may, of course, make various changes to the processes and nozzles that are described above (for purely non-exclusive informational purposes) without going beyond the scope of the invention.

1. A process for enhancing the safety of spray jets of the kind that involve the production of a nozzle with spray jet joined to a liquid feed tube, characterized by its having:
the formation of surface outcroppings (26, 28) on at least one of the components of the spray jet (16) or the feed tube (10) during production of the nozzle, and
the creation by over-molding of a plastic casing (30), once the nozzle is produced, over at least the major part of the nozzle—especially over the outcroppings (26, 28)—except for an opening (32) enclosing at least the spray jet's (16) atomization aperture (18), with the opening (32) being small enough to prevent the spray jet (16) from going through it.

2. Manufacturing process for an atomizer nozzle of the spray jet type, composed of:
a first production phase that produces a feed tube (10) enclosing a canal for drawing up liquid and a spray jet (16), and
a second production phase, where the spray jet (16) is assembled onto the feed tube (10) to create a nozzle (25) characterized by that fact that it has:
a third phase where the nozzle is made safer by the process in claim 1.

3. A process as described in claim 2, characterized by the fact that it also has a nozzle-ejection phase and all phases of the process are executed sequentially on a single automatic machine with several work stations.

4. A process as described in claim 3, characterized by the fact that the automatic machine with several work stations has at least the following: a work station for attaching the spray jet (16) to the feed tube (10) and an over-molding station, and the process has a spray jet (16) attachment handler associated with the assembly station of the automatic machine.

5. An atomizer nozzle, characterized by the fact that it has:
a liquid feed tube (10) with at least one surface outcropping (26),
a spray jet (16) with at least one surface outcropping (28), and
a casing (30) filling closely to the outcroppings (26, 28) on the feed tube (10) and on the spray jet (16).

6. An atomizer nozzle as described in claim 5, characterized by the fact that the feed tube (10) and the spray jet (16) enclose a continuous canal for moving liquid that is entirely separate from the flap (30).

7. An atomizer nozzle as described in claim 5 (15), characterized by the fact that the spray jet (16) is rigid and the passageway formed by the feed tube (10) and the spray jet (16) is continuous between the interior of the feed tube and the aperture (18) of the spray jet.

8. An atomizer nozzle as described in claim 5, characterized by the fact that it has a mobile center punch valve (36) designed to close off the aperture (18′) of the spray jet and mounted on an elastic component (38) that brings it back to its closed position.

9. An atomizer nozzle as described in claim 5, characterized by the fact that the spray jet (16′) is composed of elastomer material and, when not under pressure, creates a seal by pressing against the feed tube (10′) or against a component (34) integrated into it, whereas when the liquid is pressurized part of the elastomer spray jet (16′) moves away from the feed tube (10′) and allows the creation of a continuous passageway for liquid to circulate to the outside.

10. An atomizer nozzle as described in claim 5, characterized by the fact that the nozzle is designed for a medical treatment application and that all of the materials in contact with the liquid that is sprayed are approved for medical use.

11. An atomizer nozzle as described in claim 6 (15), characterized by the fact that the spray jet (16) is rigid and the passageway formed by the feed tube (10) and the spray jet (16) is continuous between the interior of the feed tube and the aperture (18) of the spray jet.

12. An atomizer nozzle as described in claim 8, characterized by the fact that it has a mobile center punch valve (36) designed to close off the aperture (18′) of the spray jet and mounted on an elastic component (38) that brings it back to its closed position.

13. An atomizer nozzle as described in claim 9, characterized by the fact that the spray jet (16′) is composed of elastomer material and, when not under pressure, creates a seal by pressing against the feed tube (10′) or against a component (34) integrated into it, whereas when the liquid is pressurized part of the elastomer spray jet (16′) moves away from the feed tube (10′) and allows the creation of a continuous passageway for liquid to circulate to the outside.
